(19) United States
(12) Patent Application Publication
(10) Pub. No.: US 2026/0012047 A1
(43) Pub. Date: Jan. 8, 2026

(54) Electric Machine Stator

(71) Applicant: Garrett Transportation I Inc., Torrance, CA (US)

(72) Inventors: JAMIE WASHINGTON, Deyvillers (FR); EDOUARD TRAIN-LAGARDE, Le Haillan (FR)

(73) Assignee: Garrett Transportation I Inc., Torrance, CA (US)

(21) Appl. No.: 18/761,359

(22) Filed: Jul. 2, 2024

(51) Int. Cl. H02K 1/14; H02K 1/27; H02K 3/18

(52) U.S. Cl. CPC H02K 1/14; H02K 1/27; H02K 3/18

(57) ABSTRACT

A novel stator for and electric machine has inner surface of stator teeth that, in a cross-section perpendicular to the stator axis, are a distance from a stator axis defined by a formula that is a function of azimuthal angle around the stator axis. An example of the aforementioned is a stator for and electric machine, including an outer portion and at least three teeth. The outer portion forms a loop that extends around a stator axis. The outer portion and the at least three teeth extend along the stator axis. Each one of the at least three teeth extend from the outer portion towards the stator axis and terminates at a corresponding one of at least three teeth inner surfaces. A cross section of the stator in a plane perpendicular to the stator axis defines a cross-section of the at least three teeth inner surfaces.

### BACKGROUND OF THE INVENTION

### Field of the Invention

The field of the invention is stators for electric machines.

### Description of Related Art

U.S. Pat. No. 8,436,504 to Liang discloses stators for electric machines in which the stators have teeth having irregular shapes.

### BRIEF SUMMARY OF THE INVENTION

It is an object of the invention to provide a stator for an electric machine that results in such an electric machine having reduced rotor losses and reduced forces on the stator.

Disclosed is a novel stator (10) for and electric machine, comprising: an outer portion (14); and at least three teeth (15, 16, 17, 18, 19, 20); wherein the outer portion forms a loop that extends around a stator axis (1); wherein the outer portion and the at least three teeth extend along the stator axis; wherein each one of the at least three teeth extend from the outer portion towards the stator axis and terminates at a corresponding one of at least three teeth inner surfaces (26, 27, 28, 29, 30, 31); wherein a cross section of the stator in a plane perpendicular to the stator axis defines a cross-section of the at least three teeth inner surfaces; wherein all points on the cross-section of the at least three teeth inner surfaces satisfy an equation:

$$R ( theta ) = C 1 + a sum from i = 1 to N of \{ ai * Cos ( ( i * theta * Nteeth ) / 2 ) + bi * sin ( ( i * theta * Nteeth ) / 2 ) \} ;$$

wherein R is a distance from the stator axis; wherein theta (that is è) is an azimuthal angle around the stator axis; wherein C1 is a constant; wherein a symbol “+” indicates addition;
wherein a symbol “*” indicates multiplication; wherein a term “ai” means a1 for i=1, a2 for i=2, . . . , and aN for i=N; wherein a term “bi” means b1 for i=1, b2 for i=2, . . . , and bN for i=N;
where Nteeth is a number of teeth of the stator; where N is an integer equal to or greater than 3; wherein a1 is in a range of 0 to 0.1;
wherein a2 is in a range of 0 to 0.55; wherein a3 is in a range of 0 to 1.15;
wherein b1 is in a range of 0 to 0.15; wherein b2 is in a range of 0 to 0.15; and
wherein b3 is in a range of 0 to 0.15.

Depend aspects of the novel stator include: wherein each one of the at least three teeth comprises a tooth body (21) defined by two tooth body side walls (32); each one of the two tooth body side walls connects to a corresponding one of two tooth head under surfaces (25); and wherein each of the two tooth head under surfaces extends in an azimuthal direction away from the one of the two tooth body side walls with which it connects; wherein the outer portion defines an outer surface (12) of the stator; wherein a distance from the stator axis to a point on the outer surface defines a stator radial length; wherein an extension of the stator along the stator axis defines a stator axial length; and wherein a ratio of the stator axial length to the stator radial length is between 0.001 and 1000; wherein Nteeth is less than 500; wherein Nteeth is a multiple of three; wherein Nteeth is a multiple of two; wherein Nteeth equals 6; wherein N equals 3; wherein C1 is greater than a sum from i=1 to N of a square root of {(ai**2)+bi**2)}; and wherein the term “**2” indicates a square of a quantity; wherein N is less than 500; and wherein all values for ai and bi, for all i greater than 3, are less than 100.

Disclosed is a novel stator-rotor assembly comprising the novel stator described above, and further comprising a rotor; wherein the rotor is elongated along the stator axis and has a rotor outer surface; a maximal radial point of the rotor outer surface has a maximal distance from the stator axis, of any point of the rotor outer surface; wherein the rotor outer surface has a rotor outer surface region that opposes the at least three teeth inner surfaces; and wherein R(theta) is greater than the maximal radial point distance, for all values of theta.

Depend aspects of the novel stator-rotor include: wherein the rotor defines four magnetic poles; wherein the rotor defines two magnetic poles; wherein C1 is greater than the sum of the maximal radial point distance and a sum for i=1 to N of a square root of a quantity {(ai**2)+ (bi**2)}; wherein C1 equals the sum of the maximal radial point distance, and for i=1 to N of a square root of a quantity {(ai**2)+bi**2)}, and a rotor-stator engineering tolerance length; wherein the rotor-stator engineering tolerance length is between 1 micron and one millimeter; wherein a portion of the rotor outer surface that opposes the at least three teeth inner surfaces is cylindrical; further comprising a plurality of electrical coil windings; wherein two of the at least three teeth have tooth body side walls (32) that oppose one another across a tooth gap (35); and wherein each one of the plurality of electrical coil windings comprises a portion that defines a conductive pathway that extends along the stator axis within the tooth gap; wherein a first set of the plurality of electrical coil windings are electrically conductively connected to one another to define a first electrically conductive path; a second set of the plurality of electrical coil windings are electrically conductively connected to one another to define a second electrically conductive path; and a third set of the plurality of electrical coil windings are electrically conductively connected to one another to define a third electrically conductive path; and wherein a fourth set of the plurality of electrical coil windings are electrically conductively connected to one another to define a fourth electrically conductive path; and a fifth set of the plurality of electrical coil windings are electrically conductively connected to one another to define a fifth electrically conductive path.

### BRIEF DESCRIPTION OF THE SEVERAL VIEWS OF THE DRAWING

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

In the following, an advantageous embodiment of the invention is explained with reference to the accompanying figures, wherein:

FIG. 1 is a side view of novel stator 10;

FIG. 2 is a top view of novel stator 10;

FIG. 3 is a top view of stator-rotor assembly 300 including stator 10 and rotor 39; and

FIG. 4 is a top view of stator-rotor-winding assembly 400 including stator 10, rotor 39, and electrical coil windings 42-47.

The figures are merely schematic representations and serve only to explain the invention. Identical or similarly acting elements are consistently provided with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

The figures are derived from solid models and therefore fine detail is significant. However, minor deviations in scaling of the horizontal and vertical direction may have been introduced during conversion to patent drawings, and therefore ratios of length in the horizontal and vertical directions may be inexact.

An embodiment of the claimed inventions is specified in connection with the figures. Variations within the scope of the claimed inventions are described in connection with the specified embodiment.

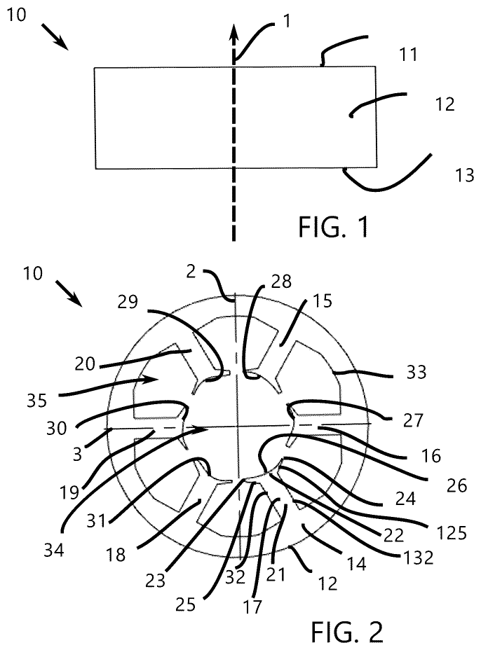

FIG. 1 shows a side view of novel stator 10 having top end 11, outer surface 12, and bottom end 13. FIG. 1 also shows stator axis 1. Stator axis 1 is for reference and is not physical structure.

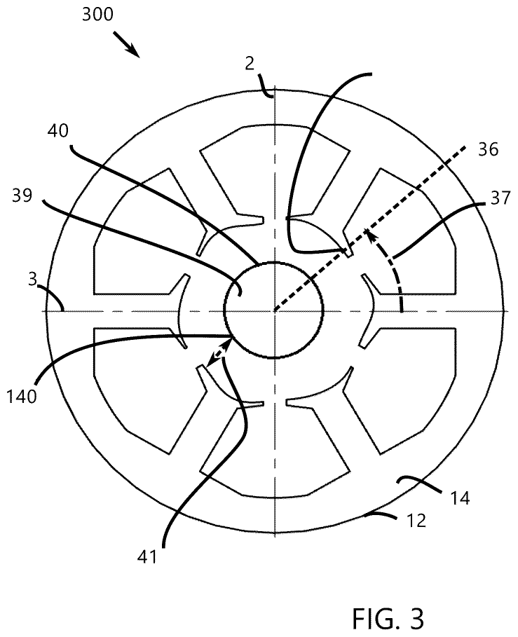

FIG. 2 shows a top view of novel stator 10. FIG. 2 shows crosshair 2 extending vertically and crosshair 3 extending horizontally. Stator axis 1 passes through the intersection of crosshair 2 and crosshair 3. Stator axis 1 define a polar axis. An angular deviation from crosshair 3 counterclockwise around stator axis 1 defines an azimuthal angle. See for example FIG. 3, azimuthal angle 37. Crosshair 2 and crosshair 3 are for reference and are not physical structure.

FIG. 2 shows novel stator 10 includes outer portion 14, tooth 15, tooth 16, tooth 17, tooth 18, tooth 19, and tooth 20.

Inner surface 33 of annular outer portion 14 extends between tooth 15 and adjacent tooth 16. Tooth gap 35 extends between tooth 19 and adjacent tooth 20. Outer portion 14 includes inner surfaces, similar to inner surface 33, between other pairs of adjacent teeth. Tooth gaps, similar to tooth gap 35, exist between other pairs of adjacent teeth. Tooth gap 35 is delimited along a radial direction by an inner surface of outer portion 14 that is similar to inner surface 33.

Tooth 17 comprises tooth body 21 and tooth head 22.

Tooth head 22 is delimited by tooth inner surface 26, tooth head side surface 23, tooth head side surface 24, tooth head under surface 25, and tooth head under surface 125. Tooth body 21 is delimited by tooth body side wall 32 and tooth body side wall 132.

Tooth inner surface 26 has an azimuthally extent around stator axis 1. Tooth inner surface 26 faces stator axis 1, separated there from by central aperture 34.

Central aperture 34 includes the space between stator axis 1 and each one of tooth inner surface 26, tooth inner surface 27, tooth inner surface 28, tooth inner surface 29, tooth inner surface 30, and tooth inner surface 31.

Tooth head side surface 23 and tooth head side surface 24 have radial extent, that is, extent along a direction perpendicular to stator axis 1. Each one of tooth head side surface 23 and tooth head side surface 24 extends radially from tooth inner surface 26 to, and connects with, a corresponding one of tooth head under surface 25 and tooth head under surface 125.

Tooth body 21 is delimited by tooth body side wall 32 and tooth body side wall 132. Tooth body side wall 32 extends from outer portion 14 to tooth head under surface 25. Tooth body side wall 132 extends from outer portion 14 to tooth head under surface 125. Each tooth head under surface extends azimuthally away from the tooth body side wall with which it connects.

The shapes of the teeth bodies, and teeth heads, other than the shapes of tooth inner surface 26, tooth inner surface 27, tooth inner surface 28, tooth inner surface 29, tooth inner surface 30, and tooth inner surface 31, vary from one another, are not critical. In other words, the structural features described above, may vary from what is shown in FIG. 2 and the shape of one tooth may vary from the shape of any other tooth. FIG. 2 shows tooth head under surface 25 having significant extent such that tooth head 22 has an extent azimuthally along an arc greater than extent of body 21 azimuthally along an arc. That is, FIG. 2 shows tooth head 22 being wider than tooth body 21. This feature is preferred but not essential. Each tooth head may have the same or lesser width as their corresponding tooth body.

The stator is preferably formed from material having a magnetic permeability that is between 1,000 and 100,000 times the magnetic permeability of vacuum (which is about one millionth Newton-Amperes squared). The stator is preferably formed from electrical steel. For example, a steel comprising between 2 and 7 molecular percent silicon and less than 0.1 molecular percent carbon.

In a cross-section perpendicular to stator axis 1, the surfaces of tooth inner surface 26, tooth inner surface 27, tooth inner surface 28, tooth inner surface 29, tooth inner surface 30, and tooth inner surface 31, satisfy the following formula:

$$R ( theta ) = C 1 + a sum from i = 1 to N of \{ ai * Cos ( ( i * theta * Nteeth ) / 2 ) + bi * sin ( ( i * theta * Nteeth ) / 2 ) \} ;$$

wherein R is a distance from the stator axis;
wherein theta (that is è) is an azimuthal angle around the stator axis; wherein C1 is a constant;
wherein a symbol “+” indicates addition; wherein a symbol “*” indicates multiplication;
wherein a term “ai” means a1 for i=1, a2 for i=2, . . . , and aN for i=N; wherein a term “bi” means b1 for i=1, b2 for i=2, . . . , and bN for i=N; where Nteeth is a number of teeth of the stator;
where N is an integer equal to or greater than 3; wherein a1 is in a range of 0 to 0.1;
wherein a2 is in a range of 0 to 0.55; wherein a3 is in a range of 0 to 1.15; wherein b1 is in a range of 0 to 0.15; wherein b2 is in a range of 0 to 0.15; and wherein b3 is in a range of 0 to 0.15.
R(theta) is periodic in the azimuthal angle theta (that is è). That is R(360 degrees+theta)=R(theta).

All cross-section perpendicular to stator axis 1, may satisfy the same R(theta) formula. Alternatively, some cross-sections perpendicular to stator axis 1 may satisfy R(theta) and others may satisfy R(theta+K) where K is a constant between zero and 360 degrees (or equivalently between 0 and 2 Pi radians where Pi represents the ratio of a perimeter length to a radius length of a circle). Various positions along the stator axis may have different K values from one another. The values for a1, a2, a3, and b1, b2, and b3 at different locations along stator axis 1 may be different from one another, so long as they are in the ranges for a1, a2, a3, and b1, b2, and b3 specified above.

For the FIG. 1 embodiment, Nteeth=3. Nteeth may be any integer equal to or greater than 3.

Preferably, a ratio of stator radial length (length in a plane perpendicular to stator axis 1 from stator axis 1 to a point on outer surface 12) to stator axial length (length parallel to stator axis 1 from a point on top end 11 to a point on bottom end (13) is between 0.001 and 1000.

Preferably, Nteeth is less than 500. Preferably, Nteeth is a multiple of three.

Preferably, Nteeth is a multiple of two. Preferably, and Nteeth equals 6.

Preferably, wherein N is less than 500. Preferably, N equals 3. Preferably, C1 is greater than a sum from i=1 to N of a square root of {(ai**2)+bi**2)} wherein the term “**2” indicates a square of a quantity.

Preferably, all values for ai and bi, for all i greater than 3, are less than 100. FIG. 3 is a top view of stator-rotor assembly 300 including stator 10 and rotor 39. Rotor 39 is configured to rotate about stator axis 1. Rotor 39 defines rotor outer surface 40. Rotor 39 comprises ferromagnetic material.

FIG. 3 shows radial line 36 extending radially away from stator axis 1.

Azimuthal angle 37 is defined to be an angular value from a line segment defined by the portion of crosshair 3 on a right side of stator-rotor assembly 300, as shown in the FIG. 3, to radial line 36. Radial line 36 and azimuthal angle 37 form no structure and are for definitional purposes to define azimuthal angle 37. The definition of azimuthal angle 37 is exemplary of an azimuthal angle. For purposes of the formula defining R(theta), the angular orientation of the zero value for azimuthal angle theta is arbitrary. That is, the zero value need not be coincident with the horizontal axis as shown in FIG. 3.

Preferably, in the region where rotor outer surface 40 opposes stator tooth inner surfaces, rotor outer surface 40 is cylindrical.

Rotor outer surface 40 may have cylindrical outer surface regions having different diameters and may regions that are not cylindrical. The cross-sectional shape of rotor 39 may vary along its length. Rotor 40 may extend less then, the same amount, or more than, an extent of stator 10 along stator axis 1.

FIG. 3 shows maximal radial point 140 of rotor outer surface 40. A rotor radial distance is the distance from stator axis 1 along a line perpendicular to stator axis 1 passing through rotor outer surface 40 to the rotor outer surface. Maximal radial point 140 is the point on rotor outer surface 40 having the largest rotor radial distance, which is defined to be the maximal radial distance. That is maximal radial point 140 has the maximal radial distance.

FIG. 3 shows rotor-stator engineering tolerance length 41. Rotor-stator engineering tolerance length is a smallest distance from maximal radial point 140 to any point satisfying the equation shown above for R(theta).

Preferably, a ratio of the rotor maximal radial distance to rotor axial length (length along which rotor 39 extends along stator axis 1) is between 0.001 and 1000.

Rotor 39 defines a plurality of magnetic poles. Rotor 39 may define 2 magnetic poles. Rotor 39 may define four magnetic poles.

Preferably, C1 is greater than the sum of the maximal radial point distance and a sum for i=1 to N of a square root of a quantity {(ai**2)+ (bi**2)}.

Preferably, C1 equals the sum of the maximal radial point distance, and for i=1 to N of a square root of a quantity {(ai**2)+bi**2)}, and a rotor-stator engineering tolerance length.

Preferably, the rotor-stator engineering tolerance length is between 1 micron and one millimeter.

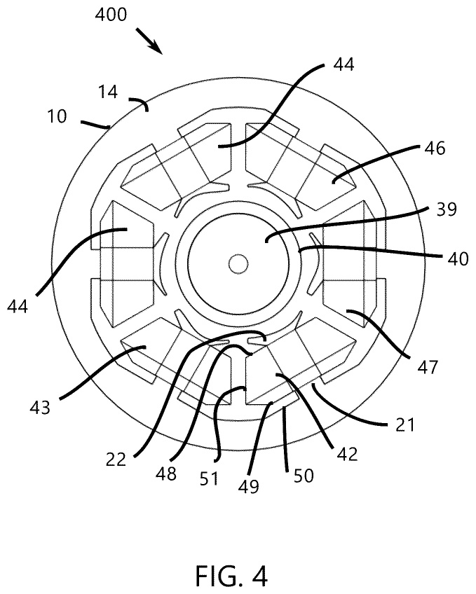

FIG. 4 is a top view of stator-rotor-winding assembly 400 including stator 10, rotor 39, electrical coil winding 42, electrical coil winding 43, electrical coil winding 44, electrical coil winding 45, electrical coil winding 46, and electrical coil winding 47.

FIG. 4 shows coil winding 42 has surfaces that define coil winding inner radius 48 and coil winding outer radius 49. Coil winding inner radius 48 is closer to stator axis 1 than coil winding outer radius 49. Coil winding 42 has a surface that define side surface 51 of electrical coil winding 42. Side surface 51 extends from coil winding inner radius 48 to coil winding outer radius 49. A portion of coil winding outer radius 49 opposes inner surface portion 50 of annular outer portion 14 of stator 10.

Pairs of adjacent teeth have tooth body side walls, such as tooth body side wall 32, that oppose one another across a tooth gap, such as tooth gap 35. (See FIG. 2.) Coil winding 42 has a portion that extends between a tooth gap between adjacent stator teeth. Each one of the plurality of electrical coil winding 42-47 has a conductive pathway that extends along the stator axis within a tooth gap, such as tooth gap 35 (see FIG. 2).

There may be more or less than six electrical coil windings. For example, there may be 2, 3, 4, 5, 6, 7, or 8 electrical coil windings.

Preferably, a first set selected from all of the electrical coil windings are electrically conductively connected to one another to define a first electrically conductive path.

Preferably, a second set selected from all of the electrical coil windings are electrically conductively connected to one another to define a second electrically conductive path.

Preferably, a third set selected from all of the electrical coil windings are electrically conductively connected to one another to define a third electrically conductive path.

Preferably, the first set, the second set, and the third set of electrical coil windings are not electrically conductively connected to one another.

There may be a fourth set selected from all of the electrical coil windings that are electrically conductively connected to one another to define a fourth electrically conductive path.

There may be a fifth set selected from all of the electrical coil windings that are electrically conductively connected to one another to define a fifth electrically conductive path.

There may be a sixth set selected from all of the electrical coil windings that are electrically conductively connected to one another to define a sixth electrically conductive path.

Preferably, the fourth set, the fifth set, and the sixth set of electrical coil windings are not electrically conductively connected to one another.

Electrically conductively connected to one another means having a very low resistance to direct current, that is current resulting from a DC voltage.

Since the devices and methods described in detail above are examples of embodiments, they can be modified to a wide extent by a person skilled in the art without departing from the scope of the invention. In particular, the mechanical arrangements and the proportions of the individual elements to one another are merely exemplary.

What is claimed is:

1. A stator (10) for and electric machine, comprising: an outer portion (14); and
at least three teeth (15, 16, 17, 18, 19, 20);
wherein the outer portion forms a loop that extends around a stator axis (1); wherein the outer portion and the at least three teeth extend along the stator axis;
wherein each one of the at least three teeth extend from the outer portion towards the stator axis and terminates at a corresponding one of at least three teeth inner surfaces (26, 27, 28, 29, 30, 31);
wherein a cross section of the stator in a plane perpendicular to the stator axis defines a cross-section of the at least three teeth inner surfaces;
wherein all points on the cross-section of the at least three teeth inner surfaces satisfy an equation:
$$R ( theta ) = C 1 + a sum from i = 1 to N of \{ ai * Cos ( ( i * theta * Nteeth ) / 2 ) + bi * sin ( ( i * theta * Nteeth ) / 2 ) \} ;$$
wherein R is a distance from the stator axis;
wherein theta (that is è) is an azimuthal angle around the stator axis; wherein C1 is a constant;
wherein a symbol “+” indicates addition; wherein a symbol “*” indicates multiplication;
wherein a term “ai” means a1 for i=1, a2 for i=2, . . . , and aN for i=N; wherein a term “bi” means b1 for i=1, b2 for i=2, . . . , and bN for i=N; where Nteeth is a number of teeth of the stator;
where N is an integer equal to or greater than 3; wherein a1 is in a range of 0 to 0.1;
wherein a2 is in a range of 0 to 0.55; wherein a3 is in a range of 0 to 1.15; wherein b1 is in a range of 0 to 0.15; wherein b2 is in a range of 0 to 0.15; and wherein b3 is in a range of 0 to 0.15.

2. The stator of claim 1, wherein each one of the at least three teeth comprises a tooth body (21) defined by two tooth body side walls (32);
each one of the two tooth body side walls connects to a corresponding one of two tooth head under surfaces (25); and
wherein each of the two tooth head under surfaces extends in an azimuthal direction away from the one of the two tooth body side walls with which it connects.

3. The stator of claim 1, wherein the outer portion defines an outer surface (12) of the stator;
wherein a distance from the stator axis to a point on the outer surface defines a stator radial length;
wherein an extension of the stator along the stator axis defines a stator axial length; and
wherein a ratio of the stator axial length to the stator radial length is between 0.001 and 1000.

4. The stator of claim 1, wherein Nteeth is less than 500.

5. The stator of claim 1, wherein Nteeth is a multiple of three.

6. The stator of claim 1, wherein Nteeth is a multiple of two.

7. The stator of claim 1, wherein Nteeth equals 6.

8. The stator of claim 1, wherein N equals 3.

9. The stator of claim 1, wherein C1 is greater than a sum from i=1 to N of a square root of {(ai**2)+bi**2)}; and
wherein the term “**2” indicates a square of a quantity.

10. The stator of claim 1, wherein N is less than 500.

11. The stator of claim 1, wherein all values for ai and bi, for all i greater than 3, are less than 100.

12. A stator-rotor assembly comprising the stator of claim 1, further comprising:
a rotor;
wherein the rotor is elongated along the stator axis and has a rotor outer surface;
a maximal radial point of the rotor outer surface has a maximal distance from the stator axis, of any point of the rotor outer surface;
wherein the rotor outer surface has a rotor outer surface region that opposes the at least three teeth inner surfaces; and
wherein R(theta) is greater than the maximal radial point distance, for all values of theta.

13. The stator-rotor assembly of claim 12, wherein the rotor defines four magnetic poles.

14. The stator-rotor assembly of claim 12, wherein the rotor defines two magnetic poles.

15. The stator-rotor assembly of claim 12, wherein C1 is greater than the sum of the maximal radial point distance and a sum for i=1 to N of a square root of a quantity {(ai**2)+ (bi**2)}.

16. The stator-rotor assembly of claim 12, wherein C1 equals the sum of the maximal radial point distance, and for i=1 to N of a square root of a quantity {(ai**2)+bi**2)}, and a rotor-stator engineering tolerance length.

17. The stator-rotor assembly of claim 16, wherein the rotor-stator engineering tolerance length is between 1 micron and one millimeter.

18. The stator-rotor assembly of claim 12, wherein a portion of the rotor outer surface that opposes the at least three teeth inner surfaces is cylindrical.

19. A stator-winding assembly comprising the stator of claim 1, further comprising a plurality of electrical coil windings;
wherein two of the at least three teeth have tooth body side walls (32) that oppose one another across a tooth gap (35); and
wherein each one of the plurality of electrical coil windings comprises a portion that defines a conductive pathway that extends along the stator axis within the tooth gap.

20. The stator-winding assembly of claim 19, wherein:
a first set of the plurality of electrical coil windings are electrically conductively connected to one another to define a first electrically conductive path;
a second set of the plurality of electrical coil windings are electrically conductively connected to one another to define a second electrically conductive path; and
a third set of the plurality of electrical coil windings are electrically conductively connected to one another to define a third electrically conductive path.

21. The stator-winding assembly of claim 19, wherein:
a first set of the plurality of electrical coil windings are electrically conductively connected to one another to define a first electrically conductive path; a second set of the plurality of electrical coil windings are electrically conductively connected to one another to define a second electrically conductive path;
a third set of the plurality of electrical coil windings are electrically conductively connected to one another to define a third electrically conductive path;
a fourth set of the plurality of electrical coil windings are electrically conductively connected to one another to define a fourth electrically conductive path; and
a fifth set of the plurality of electrical coil windings are electrically conductively connected to one another to define a fifth electrically conductive path.
